(19) United States
(12) Patent Application Publication
(10) Pub. No.: US 2007/0292565 A1
(43) Pub. Date: Dec. 20, 2007

(54) Luis Picado "Sicilian Edger"

(76) Inventor: Luis Picado, Howell, NJ (US)

Correspondence Address: Luis Picado, 70 Ruffian Way, Howell, NJ, 07731, US

(21) Appl. No.: 11/454,099

(22) Filed: Jun. 16, 2006

(51) Int. Cl. A21D 13/00

(52) U.S. Cl. 426/94

(57) ABSTRACT

This invention, a Sicilian Edger is a tool for the pizza industry to save time and improve quality of its pizza products. It is a square tool, with a handle, that pushes the air out of the center of a Sicilian pizza pie, causing the outer edge or perimeter rise, leaving a raised edge approximately one inch wide. This tool is used when the dough is semi cooked and hot. While the Sicilian pizza pie is still in the oven, the tool is inserted into the oven and presses firmly onto the center of the Sicilian pie while moving the tool slightly from side to side, with an up and down motion. This creates a depression in the pizza dough in a single operation, preventing the subsequent sauce, cheeses and other toppings from running off. The square tool, with rounded corners, is constructed entirely of aluminum, making it durable yet light weight, the screen in the square section allows hot air and steam to freely escape from the Sicilian pizza dough.

### BACKGROUND AND SUMMARY OF THE INVENTION

The present invention relates to a Sicilian Edger, which, in a single operation, creates a raised edge in Sicilian pizza dough, preventing toppings from running over the edge of the pie.

Creating the raised edge for Sicilian pizza has been problematic. Conventional methods consisting of the use of forks or spatulas to create the raised edge are tedious and time-consuming.

The object of the present invention is to vastly improve production speed and allow consistent quality in forming the raised edge of the pie.

The Sicilian Edger is used when the dough is semi-cooked and hot to create the edge around the Sicilian pizza pie. While the pie is still in the oven the edger is pressed firmly into the center of the pie while moving slightly up and down from side to side and up and down until the raised edge is formed, essentially creating a depression in the pie. In doing the conventional way, with a fork or a spatula, the pie must be removed from the oven, the edge made by hand and then inserted back into the oven again.

### DECRIPTION OF THE PREFERRED EMBODIMENT

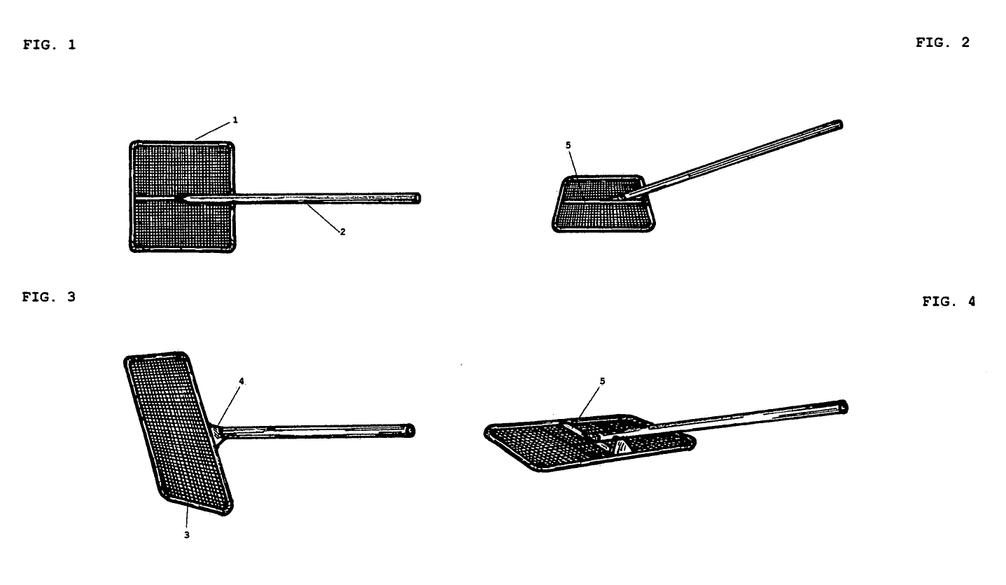

Referring to FIG. 1, illustrated are the basic components of the Sicilian Edger including a square metal frame 1, and tubular handle 2.

Considering FIG. 2, illustrated is the positional relationship between the before mentioned frame and handle assembly, allowing for the tool to be inserted into a pizza oven and 5 the support bracket

In FIG. 3, the wire screen 3 is illustrated. This screen surface makes contact with the hot pizza dough during use of the Sicilian Edger. Also illustrated is the handle support bracket 4 which maintains the handles proper elevation.

In FIG. 4, another view of the support bracket is illustrated, as well as the position of the center brace 5 and its relationship to the frame and handle assembly.

I claim:

1. The present invention, Sicilian Edger, a Sicilian pizza dough-pressing manual tool, consisting of a square frame, covered with coarse screen, to which is attached a tubular handle; in which the invention, in a single operation, creates a raised edge or border in Sicilian pizza dough to hold sauce, cheeses and toppings in place.
